(19) United States
(12) Patent Application Publication
(10) Pub. No.: US 2024/0301911 A1
(43) Pub. Date: Sep. 12, 2024

(54) DEVICES AND SYSTEMS FOR LOCKING AN AMMUNITION CONTAINER

(71) Applicants: Connor Laney, West Lafayette, IN (US); Charles Laney, Newark, DE (US)

(72) Inventors: Connor Laney, West Lafayette, IN (US); Charles Laney, Newark, DE (US)

(21) Appl. No.: 18/600,668

(22) Filed: Mar. 9, 2024

Related U.S. Application Data
(60) Provisional application No. 63/451,615, filed on Mar. 12, 2023.

(51) Int. Cl. F16B 39/00; F16B 23/00

(52) U.S. Cl. CPC F16B 39/00; F16B 23/00

(57) ABSTRACT

Devices and systems for locking an ammunition container. A locking bolt of the present disclosure includes a head portion, an extension portion extending from the head portion or from an optional flange portion adjacent the head portion, the extension portion having a threaded portion, and a channel defined through a portion of the extension portion, the channel configured to receive part of a fastener element therethrough.

### PRIORITY

The present application is related to, and claims the priority benefit of, U.S. provisional patent application Ser. No. 63/451,615, filed on Mar. 12, 2023, the contents of which are incorporated into the present disclosure directly and by reference in their entirety.

### BACKGROUND

The present disclosure pertains to ammunition boxes or cans, such as, for example, the U.S. military 50 Cal ammo can, which is closable but not lockable. This leaves it vulnerable to tampering and potential theft of contents. A mechanism for being able to lock said ammunition boxes or cans would be well received in the marketplace.

### BRIEF SUMMARY

An exemplary solution to not being able to lock an ammunition box or can is referenced herein, comprising a locking bolt that facilitates locking with any lock that has a diameter of its shank/shackle less than the eye hole (aperture or channel) defined within said locking bolt.

The present disclosure includes disclosure of a locking bolt, as shown and or described herein.

The present disclosure includes disclosure of a locking bolt, comprising a head portion having an extension portion perpendicularly extending therefrom, a threaded portion extending from the head portion or from an optional flange portion adjacent the head portion, and a channel defined through a portion of the extension portion, the channel configured to receive part of a fastener element therethrough.

The present disclosure includes disclosure of a locking bolt, configured to at least partially fit through apertures defined within an ammunition box or can.

The present disclosure includes disclosure of a locking bolt, used in connection with a nut to lock an ammunition box or can.

The present disclosure includes disclosure of a system or kit, comprising a locking bolt of the present disclosure, a nut configured to threadably couple to a threaded portion of the locking bolt, one or more optional washers, and an optional fastener element.

The present disclosure includes disclosure of a method of locking an ammunition box or can, as described herein.

The present disclosure includes disclosure of a locking bolt, comprising a head portion, an extension portion extending from the head portion or from an optional flange portion adjacent the head portion, the extension portion having a threaded portion, and a channel defined through a portion of the extension portion, the channel configured to receive part of a fastener element therethrough.

The present disclosure includes disclosure of a locking bolt, configured to at least partially fit through apertures defined within an ammunition box or can.

The present disclosure includes disclosure of a locking bolt, used in connection with a nut to lock an ammunition box or can.

The present disclosure includes disclosure of a locking bolt, forming part of a system or kit, the system or kit further comprising a nut configured to threadably engage the threaded portion of the extension portion.

The present disclosure includes disclosure of a system or kit, further comprising a first washer configured to be positioned around the extension portion.

The present disclosure includes disclosure of a system or kit, further comprising a second washer configured to be positioned around the extension portion.

The present disclosure includes disclosure of a system or kit, further comprising the fastener element.

The present disclosure includes disclosure of a system or kit, wherein the fastener element comprises a lock.

The present disclosure includes disclosure of a system or kit, wherein the fastener element comprises a wire or chain.

The present disclosure includes disclosure of a locking bolt, wherein the extension portion also comprises a non-threaded portion.

The present disclosure includes disclosure of a locking bolt, wherein the channel is defined through the non-threaded portion.

The present disclosure includes disclosure of a locking bolt, wherein the head portion comprises an obround shape.

The present disclosure includes disclosure of a locking bolt, wherein the head portion comprises a square shape.

The present disclosure includes disclosure of a locking bolt, wherein the head portion comprises a hexagonal shape.

The present disclosure includes disclosure of a system or kit, comprising a locking bolt of the present disclosure and a nut configured to threadably couple to the threaded portion of the locking bolt.

The present disclosure includes disclosure of a system or kit, further comprising at least one washer and a fastener element.

The present disclosure includes disclosure of a system or kit, comprising a locking bolt of the present disclosure, a nut configured to threadably couple to a threaded portion of the locking bolt, optionally one or more washers, and a fastener element.

The present disclosure includes disclosure of a method of locking an ammunition box or can, comprising positioning the extension portion of an exemplary locking bolt of the present disclosure through apertures defined within a side wall and a lid of an ammunition box or can, whereby the head portion of the locking bolt is located within said ammunition box or can, and placing a nut upon the threaded portion of the locking nut and tightening the same.

The present disclosure includes disclosure of a method further comprising the step of positioning a portion of a lock through the channel defined within the extension portion of the locking bolt and locking said lock.

The present disclosure includes disclosure of a method further comprising the step of positioning a portion of a wire or chain through the channel defined within the extension portion of the locking bolt and using a lock to lock said wire or chain.

### BRIEF DESCRIPTION OF THE DRAWINGS

The disclosed embodiments and other features, advantages, and disclosures contained herein, and the matter of attaining them, will become apparent and the present disclosure will be better understood by reference to the following description of various exemplary embodiments of the present disclosure taken in conjunction with the accompanying drawings, wherein:

FIG. 1 shows a perspective view of a locking bolt, according to at least one embodiment of the present disclosure;

FIG. 2 shows an exploded view of components used with a locking bolt to lock an ammunition box or can, according to at least one embodiment of the present disclosure;

FIG. 3 shows an assembled view of components used with a locking bolt to lock an ammunition box or can, according to at least one embodiment of the present disclosure;

FIG. 4 shows an assembled view of components used with a locking bolt to lock an ammunition box or can using a fastener element, according to at least one embodiment of the present disclosure; and

FIG. 5 shows bottom views of various embodiments of locking bolts, according to at least some embodiments of the present disclosure

As such, an overview of the features, functions and/or configurations of the components depicted in the various figures will now be presented. It should be appreciated that not all of the features of the components of the figures are necessarily described and some of these non-discussed features (as well as discussed features) are inherent from the figures themselves. Other non-discussed features may be inherent in component geometry and/or configuration. Furthermore, wherever feasible and convenient, like reference numerals are used in the figures and the description to refer to the same or like parts or steps. The figures are in a simplified form and not to precise scale.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

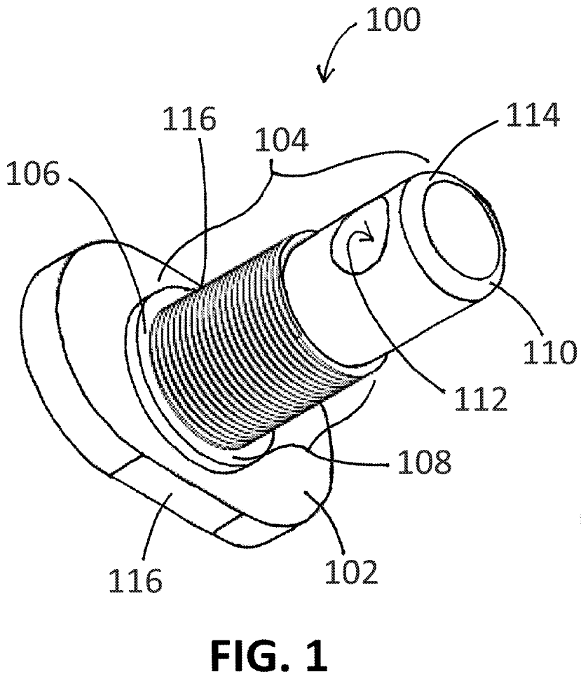

An exemplary locking bolt of the present disclosure is shown in FIG. 1. As shown therein, locking bolt 100 comprises a head portion 102 having an extension portion 104 perpendicularly extending therefrom. An optional flange portion 106 immediately adjacent the head portion 102 can be present as well, as shown in FIG. 1. A threaded portion 108 can extend from head portion 102 or flange portion 106 a distance toward a distal end 110 of locking bolt 100. In at least some embodiments, threaded portion 108 extends at or about 20%, 30%, 40%, 50%, 60%, or less or more, the general length of extension portion 104.

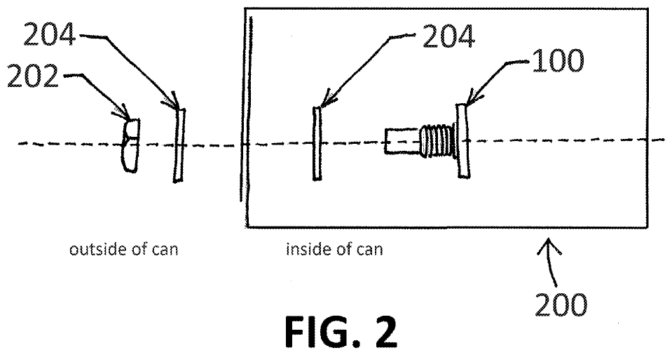

Exemplary locking bolts 100 of the present disclosure also have a channel 112 defined through a portion of extension portion 104, such as shown in FIG. 1. Said channel 112 is configured to receive a portion of a lock, wire, or chain (exemplary fastener elements 300) therethrough, so to facilitate locking said locking bolt 100 in place, such as relative to an ammunition box or can 200, as shown in FIG. 2. Said channel 112 is generally defined through a portion of extension portion 104 closer to a distal end 110 of locking bolt 100 versus a head portion 102 of said locking bolt 100.

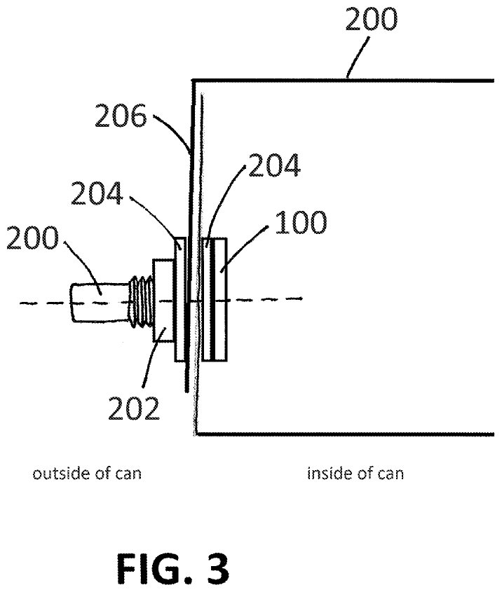

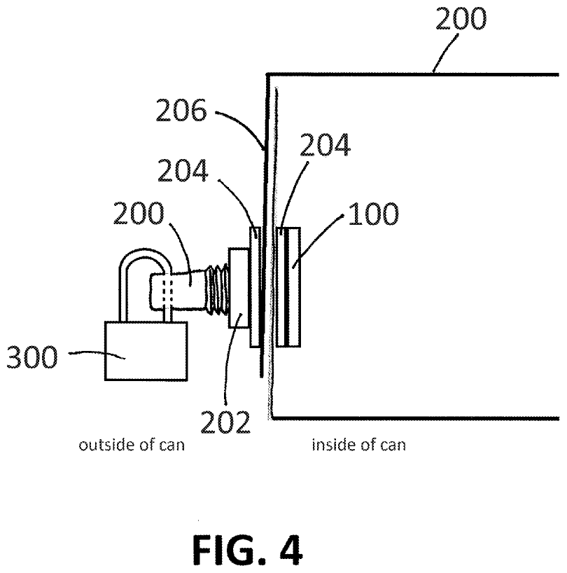

Exemplary locking bolts 100 of the present disclosure can also comprise a distal tapered portion 114, such as shown in FIG. 1. Said distal tapered portion 114 is configured so that it is easier to position a distal end 110 of locking bolt 100 into a hole, such as a hole defined within an ammunition box or can 200. Tapered portion 114 can also facilitate closing a lid 206 of an ammunition box or can 200 with part of locking bolt 100 present within an opening defined within ammunition box or can 200, such as shown in FIGS. 3 and 4.

Procedurally, a locking bolt 100 of the present disclosure can be positioned through openings defined within a wall and a lid of an ammunition box or can 200 from the inside of said ammunition box or can 200 so that head portion 102 is positioned within ammunition box or can 200 and so that distal end 110 of locking bolt 100 is present outside ammunition box, such as shown in FIG. 3. Threaded portion 108 of locking bolt 100 can then threadably receive a nut 202 thereon, whereby nut 202 retains locking bolt 100 in place relative to ammunition box or can 200. Optional washers 204 (such as rubber or metal washers 204) can be used inside and/or outside of ammunition box or can 200, such as shown in FIG. 3, as may be desired.

Said washers 204 can have a notch defined therein to ensure a tight seal helping to protect it from the elements and create maximum contact surface between the locking bolt 100 and the ammunition box or can 200. Use of rubber washers 204, for example, can help generate an air-tight or a water-tight seal.

A fastener element 300, such as part of a lock, a chain, or a wire, can be positioned through channel 112 and secured, such as by locking lock or using a lock in connection with a chain or wire, to effectively lock the ammunition box or can 200. Any number of fastener elements 300 can be used so long as their dimensions intended to fit within channel 112 are sized and shaped to fit therethrough.

Exemplary locking bolts 100 of the present disclosure can comprise a solid piece of machined steel or other metal, including other metal alloys.

As shown in FIG. 1, an exemplary head portion 102 of a locking bolt 100 of the present disclosure can have at least two parallel flat portions 116 so that a user can use a wrench, pliers, or another tool to engage head portion 102 of locking bolt 100 while threading and tightening nut 202 thereto as noted above. Such a design is a modification of a generally circular or otherwise rounded head portion 102, noting, however, that any number of sizes and shapes or dimensions of head portions 102 could be used so long as they are generally larger than a diameter of extension portion 104. For example, a head portion can comprise an obround shape, as shown in FIG. 1, having two flat sides and two rounded portions connecting the two flat sides.

As referenced herein, the locking bolt 100 of the present disclosure allows a user the ability to lock a standard US 50 caliber ammo can and other compatibility sized ammunition boxes or cans 200. A user may need to drill a hole into the ammunition box or can 200 within a hole already present within latch 206. The locking bolt 100 would then be placed within the hole from the inside of the ammunition box or can 200, such as shown in FIGS. 3 and 4, whereby when secured with a nut 202, a fastener element 300 can be placed through channel 112 of locking bolt to lock the same.

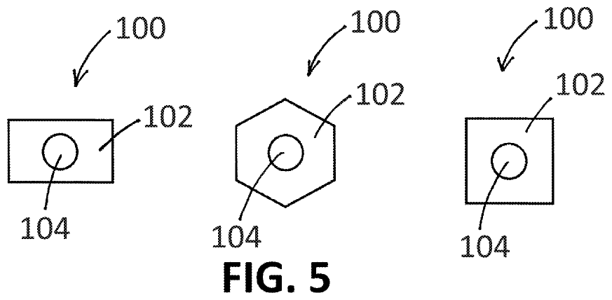

Head portions 102 of locking bolts 100 of the present disclosure can have any number of shapes other than as shown in FIG. 1, such as a rectangular shape, a hexagonal shape, or a square shape, as shown in FIG. 5.

An exemplary kit or system of the present disclosure can comprise one or more locking bolts 100, one or more nuts 202, optionally one or more washers 204, and optionally one or more fastener elements 300, such as shown in FIG. 4.

While various embodiments of devices and systems and methods for using the same have been described in considerable detail herein, the embodiments are merely offered as non-limiting examples of the disclosure described herein. It will therefore be understood that various changes and modifications may be made, and equivalents may be substituted for elements thereof, without departing from the scope of the present disclosure. The present disclosure is not intended to be exhaustive or limiting with respect to the content thereof.

Further, in describing representative embodiments, the present disclosure may have presented a method and/or a process as a particular sequence of steps. However, to the extent that the method or process does not rely on the particular order of steps set forth therein, the method or process should not be limited to the particular sequence of steps described, as other sequences of steps may be possible. Therefore, the particular order of the steps disclosed herein should not be construed as limitations of the present disclosure. In addition, disclosure directed to a method and/or process should not be limited to the performance of their steps in the order written. Such sequences may be varied and still remain within the scope of the present disclosure.

1. A locking bolt, comprising:
a head portion;
an extension portion extending from the head portion or from an optional flange portion adjacent the head portion, the extension portion having a threaded portion; and
a channel defined through a portion of the extension portion, the channel configured to receive part of a fastener element therethrough.

2. The locking bolt of claim 1, configured to at least partially fit through apertures defined within an ammunition box or can.

3. The locking bolt of claim 23, used in connection with a nut to lock an ammunition box or can.

4. The locking bolt of claim 1, forming part of a system or kit, the system or kit further comprising:
a nut configured to threadably engage the threaded portion of the extension portion.

5. The system or kit of claim 4, further comprising:
a first washer configured to be positioned around the extension portion.

6. The system or kit of claim 5, further comprising:
a second washer configured to be positioned around the extension portion.

7. The system or kit of claim 4, further comprising:
the fastener element.

8. The system or kit of claim 7, wherein the fastener element comprises a lock.

9. The system or kit of claim 7, wherein the fastener element comprises a wire or chain.

10. The locking bolt of claim 1, wherein the extension portion also comprises a non-threaded portion.

11. The locking bolt of claim 10, wherein the channel is defined through the non-threaded portion.

12. The locking bolt of claim 1, wherein the head portion comprises an obround shape.

13. The locking bolt of claim 1, wherein the head portion comprises a square shape.

14. The locking bolt of claim 1, wherein the head portion comprises a hexagonal shape.

15. A system or kit, comprising:
the locking bolt of claim 1; and
a nut configured to threadably couple to the threaded portion of the locking bolt.

16. The system or kit of claim 15, further comprising:
at least one washer; and
a fastener element.

17. A system or kit, comprising:
a locking bolt, comprising:
a head portion;
an extension portion extending from the head portion or from an optional flange portion adjacent the head portion, the extension portion having a threaded portion; and
a channel defined through a portion of the extension portion, the channel configured to receive part of a fastener element therethrough;
a nut configured to threadably couple to the threaded portion of the locking bolt; and
a fastener element.

18. A method of locking an ammunition box or can, comprising:
positioning the extension portion of the locking bolt of claim 1 through apertures defined within a side wall and a lid of an ammunition box or can, whereby the head portion of the locking bolt is located within said ammunition box or can; and
placing a nut upon the threaded portion of the locking nut and tightening the same.

19. The method of claim 18, further comprising the step of:
positioning a portion of a lock through the channel defined within the extension portion of the locking bolt and locking said lock.

20. The method of claim 18, further comprising the step of:
positioning a portion of a wire or chain through the channel defined within the extension portion of the locking bolt and using a lock to lock said wire or chain.
